(19) United States
(12) Patent Application Publication
(10) Pub. No.: US 2016/0233915 A1
(43) Pub. Date: Aug. 11, 2016

(54) COMMUNICATION DEVICE AND ELECTRONIC DEVICE

(71) Applicant: MediaTek Inc., Hsin-Chu (TW)

(72) Inventors: Chen-Fang TAI, New Taipei City (TW); Chung-Yu HUNG, Taipei City (TW); Ting-Wei KANG, Kaohsiung City (TW)

(21) Appl. No.: 14/926,734

(22) Filed: Oct. 29, 2015

Related U.S. Application Data
(60) Provisional application No. 62/153,613, filed on Apr. 28, 2015.
(60) Provisional application No. 62/114,248, filed on Feb. 10, 2015.

(51) Int. Cl. H04B 1/40; H04W 88/06; H04B 1/00

(52) U.S. Cl. CPC H04B 1/40; H04B 1/006; H04W 88/06

(57) ABSTRACT

A communication device includes an antenna, a frequency dividing circuit, and at least one variable impedance circuit. The frequency dividing circuit has a common port coupled to the antenna and at least one output port. The frequency dividing circuit is configured to divide a frequency range received from the common port into a plurality of frequency sub-ranges and output at least one of the frequency sub-ranges respectively at the output port. Each variable impedance circuit is coupled between a corresponding output port of the frequency dividing circuit and a first reference voltage. Each variable impedance circuit provides a respective variable impedance value switched between different respective impedance values.

### CROSS REFERENCE TO RELATED APPLICATIONS

This application claims the benefit of U.S. Provisional Application No. 62/114,248, filed on Feb. 10, 2015, and further claims the benefit of U.S. Provisional Application No. 62/153,613, filed on Apr. 28, 2015, the entirety of which is incorporated by reference herein.

### BACKGROUND OF THE INVENTION

1. Field of the Invention

The disclosure generally relates to a communication device, and more particularly, to a communication device which can support communication in multiple frequency components/sub-ranges or the field of carrier aggregation.

2. Description of the Related Art

To meet LTE-A (Long Term Evolution-Advance) requirements, support of wider transmission bandwidths is required than the 20 MHz bandwidth specified in 3GPP (3rd Generation Partnership Project) Release 8/9. The preferred solution to this is carrier aggregation, which is one of the most distinctive features of 4G LTE-A. Carrier aggregation allows expansion of effective bandwidth delivered to a user terminal through concurrent utilization of radio resources across multiple carriers. Multiple component carriers are aggregated to form a larger overall transmission bandwidth.

However, the technology of carrier aggregation requires multiple frequency bands or sub-ranges and wide frequency bandwidth. It has become a critical challenge for engineers to design such an antenna system to meet the requirements of carrier aggregation.

### BRIEF SUMMARY OF THE INVENTION

In one exemplary embodiment, the disclosure is directed to a communication device including an antenna, a frequency dividing circuit, and at least one variable impedance circuit. The frequency dividing circuit has a common port coupled to the antenna and at least one output port. The frequency dividing circuit is configured to divide a frequency range received from the common port into a plurality of frequency sub-ranges and output at least one of the frequency sub-ranges respectively at the at least one output port. Each variable impedance circuit is coupled between a corresponding one of the at least one output port of the frequency dividing circuit and a respective first reference voltage. Each variable impedance circuit provides a respective variable impedance value switched between different respective impedance values.

In some embodiments, the antenna switches between the different respective impedance values in at least one of the frequency sub-ranges independently from the other one or more frequency sub-ranges.

In some embodiments, the first reference voltage is a ground voltage.

In some embodiments, the frequency dividing circuit is a passive element.

In some embodiments, the frequency dividing circuit is an active element.

In some embodiments, a range of at least one of the at least one of the frequency sub-ranges respectively output at the at least one output port is dynamically changed.

In some embodiments, each output port of the frequency dividing circuit is coupled to a respective one of the at least one variable impedance circuit.

In some embodiments, at least one output port of the frequency dividing circuit is not coupled to any of the at least one variable impedance circuit.

In some embodiments, the at least one output port of the frequency dividing circuit not coupled to any of the at least one variable impedance circuit is float, short to a second reference voltage different or the same as the first reference voltage, or coupled to a loading element.

In some embodiments, the frequency dividing circuit includes a low-pass filter, a high-pass filter, a band-pass filter, a diplexer, duplexer, tri-plexer, quad-plexer, or a combination thereof.

In some embodiments, at least one of the at least one variable impedance circuit includes: a first terminal, a second terminal, a plurality of loading elements, and a switch element. The first terminal is coupled to the first reference voltage. The second terminal coupled to one of the at least one output port of the frequency dividing circuit. The loading elements are coupled to one of the first terminal and the second terminal, and have different impedances. The switch element is coupled to the other one of the first terminal and the second terminal and switching between the loading elements.

In some embodiments, the switch element includes a first terminal and a second terminal. The first terminal is coupled to the output port of the frequency dividing circuit. The second terminal is switchably coupled to one of the loading elements.

In some embodiments, at least one of the loading elements includes one or more inductors, one or more variable capacitors, one or more fixed capacitors, or a combination thereof.

In some embodiments, at least one of the at least one variable impedance circuit includes a tuner. The tuner is coupled to the first reference voltage and generating different impedance values.

In some embodiments, the communication device further includes a processor. The processor receives communication information directly or indirectly from the antenna, and generates at least one control signal according to the communication information. An impedance value of each of the at least one variable impedance circuit is determined according to one of the at least one control signal.

In some embodiments, the communication device further includes a coupler. The coupler is coupled between the antenna and the processor, and provides the communication information from the antenna to the processor.

In some embodiments, the antenna includes a feeding point, one or more radiation elements, and a tuning point. The feeding point is coupled to a signal source. One of the one or more radiation elements is coupled to the feeding point. The tuning point is coupled through the frequency dividing circuit and the at least one variable impedance circuit to the first reference voltage.

In some embodiments, the antenna further includes a ground/reference plane. The ground/reference plane provides the first reference voltage.

In some embodiments, the antenna further includes one or more reference points. Each of the one or more reference points is coupled to a second reference voltage which is the same or different from the first reference voltage and a corresponding one of the one or more radiation elements.

In another exemplary embodiment, the disclosure is also directed to An electronic device in a communication device, comprising: an antenna terminal, configured to be coupled to an antenna; a frequency dividing circuit, having a common port coupled to the antenna terminal and at least one output port, and configured to divide a frequency range received from the common port into a plurality of frequency sub-ranges and output at least one of the frequency sub-ranges respectively at the at least one output port; and at least one variable impedance circuit, each coupled between a corresponding one of the at least one output port of the frequency dividing circuit and a respective first reference voltage, and providing a respective variable impedance value switched between different respective impedance values.

### BRIEF DESCRIPTION OF DRAWINGS

The invention can be more fully understood by reading the subsequent detailed description and examples with references made to the accompanying drawings, wherein:

FIG. 1 is a diagram of a communication device according to an embodiment of the invention;

FIG. 2A is a diagram of a communication device according to an embodiment of the invention;

FIG. 2B is a diagram of a communication device according to an embodiment of the invention;

FIG. 3A is a diagram of a communication device according to an embodiment of the invention;

FIG. 3B is a diagram of a communication device according to an embodiment of the invention;

FIG. 3C is a diagram of a diplexer according to an embodiment of the invention;

FIG. 4A is a diagram of a variable impedance circuit according to an embodiment of the invention;

FIG. 4B is a diagram of a variable impedance circuit according to an embodiment of the invention;

FIG. 4C is a diagram of a variable impedance circuit according to an embodiment of the invention;

FIG. 4D is a diagram of a variable impedance circuit according to an embodiment of the invention;

FIGS. 5A to 5I are diagrams of communication devices according to some embodiments of the invention;

FIG. 5J is a diagram of a variable impedance circuit according to an embodiment of the invention;

FIG. 6 is a diagram of a communication device according to an embodiment of the invention;

FIG. 7 is a diagram of a communication device according to an embodiment of the invention; and

FIG. 8 is a diagram of return loss of an antenna of a communication device according to an embodiment of the invention.

### DETAILED DESCRIPTION OF THE INVENTION

In order to illustrate the purposes, features and advantages of the invention, the embodiments and figures of the invention will be described in detail as follows.

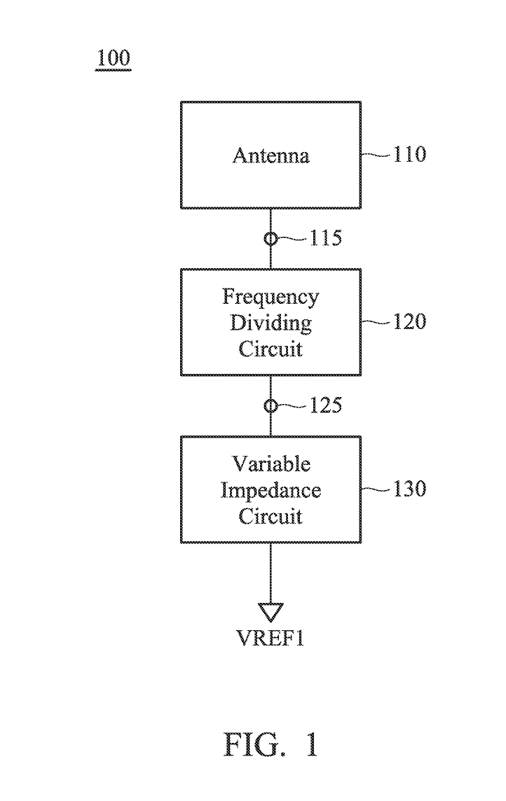

FIG. 1 is a diagram of a communication device 100 according to an embodiment of the invention. For example, the communication device 100 may be a smartphone, a tablet computer, or a notebook computer. The communication device 100 can support the technology of carrier aggregation in the field of LTE-A (Long Term Evolution-Advance). As shown in FIG. 1, the communication device 100 includes an antenna 110, a frequency dividing circuit 120, and at least one variable impedance circuit 130. The frequency dividing circuit 120 has a common port 115 coupled to the antenna 110, and at least one output port 125, each coupled to one of the at least one variable impedance circuit 130. More specifically, in the implementation shown in FIG. 1, one output port 125 is coupled to the variable impedance circuit 130. In other implementations where the frequency dividing circuit 120 has multiple output ports 125, one or more of the output ports 125 may be coupled to one or more variable impedance circuits 130, respectively. The frequency dividing circuit 120 is configured to divide a frequency range received from the common port 115 into multiple frequency sub-ranges, and is configured to output at least one of the respective frequency sub-ranges respectively at the at least one output port 125. More specifically, in the implementation shown in FIG. 1, one of the frequency sub-ranges is output at the output port 125. In other implementations where the frequency dividing circuit 120 has multiple output ports 125, one or more of the frequency sub-ranges may be output at one or more of the output ports, respectively. Each of the at least one variable impedance circuit 130 can provide a respective variable impedance value switched between different respective impedance values.

In one embodiment, the range of the frequency sub-ranges respectively output at the at least one output port 125 are fixed. In other embodiments, the range of at least one of the frequency sub-ranges respectively output at the output port 125 is dynamically changed. In some embodiments, the frequency dividing circuit 120 is a passive element. In alternative embodiments, the frequency dividing circuit 120 is an active element. For example, the frequency dividing circuit 120 may include a low-pass filter, a high-pass filter, a band-pass filter, a diplexer, duplexer, tri-plexer, quad-plexer, or a combination thereof.

Each of the variable impedance circuits 130 can be coupled between a corresponding output port 125 of the frequency dividing circuit 120 and a respective reference voltage, such as VREF1. It is noted that in implementation, the variable impedance circuits 130 may be coupled to the same reference voltage VREF1 or respective reference voltages VRE1s have the same or different voltage levels. In some embodiments, each output port 125 of the frequency dividing circuit 120 is coupled to a respective variable impedance circuit 130. In some embodiments, at least one output port 125 of the frequency dividing circuit 120 is not coupled to any of the variable impedance circuits 130. In some embodiments where at least one output port 125 of the frequency dividing circuit 120 is not coupled to any of the variable impedance circuits 130, the output port 125 of the frequency dividing circuit 120 that is not coupled to any of the variable impedance circuits 130 is float, short to a second reference voltage VREF2 different or the same as the first reference voltage VREF1, or coupled to a loading element.

Generally speaking, the antenna 110 operates in multiple frequency bands by using the frequency dividing circuit 120 and the variable impedance circuit 130. With the cooperation of the frequency dividing circuit 120 and the at least one variable impedance circuit 130, the antenna 110 can switch between the different respective impedance values in at least one of the frequency sub-ranges independently from the other frequency sub-ranges. In addition, the frequency dividing circuit 120 can be configured to suppress harmonic interference in the antenna 110. Please refer to the following embodiments for detailed descriptions.

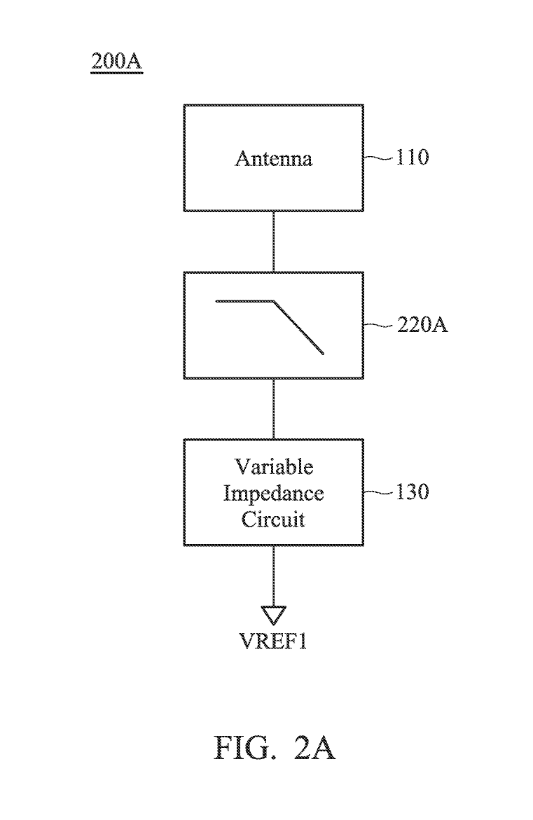

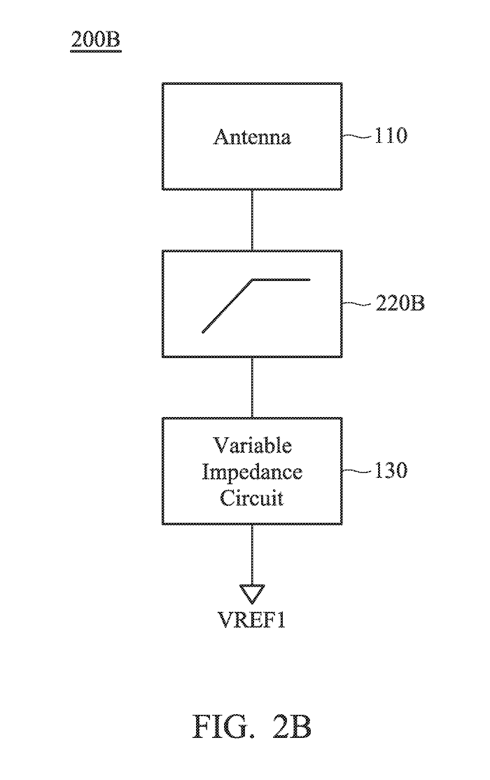

FIG. 2A is a diagram of a communication device 200A according to an embodiment of the invention. In the embodiment of FIG. 2A, the frequency dividing circuit of the communication device 200A is a low-pass filter 220A, and the reference voltage VREF1 is a ground voltage VSS but is not limited thereto. The low-pass filter 220A can pass low-frequency signals and block high-frequency signals. With such a design, the high frequency sub-range and the low frequency sub-range are separated into different signal paths without tending to interfere with each other and the low frequency sub-range is output from the output port of the frequency dividing circuit. Accordingly, the antenna 110 can switch between the different respective impedance values of the variable impedance circuit 130 in the low frequency sub-ranges independently from the high frequency sub-range.

FIG. 2B is a diagram of a communication device 200B according to an embodiment of the invention. In the embodiment of FIG. 2B, the frequency dividing circuit of the communication device 200B is a high-pass filter 220B, and the reference voltage VREF1 is a ground voltage VSS. The high-pass filter 220B can pass high-frequency signals and block low-frequency signals. With such a design, the high frequency sub-range and the low frequency sub-range are separated into different signal paths without tending to interfere with each other and the high frequency sub-range is output from the output port of the frequency dividing circuit. Accordingly, the antenna 110 can switch between the different respective impedance values of the variable impedance circuit 130 in the high frequency sub-ranges independently from the low frequency sub-range.

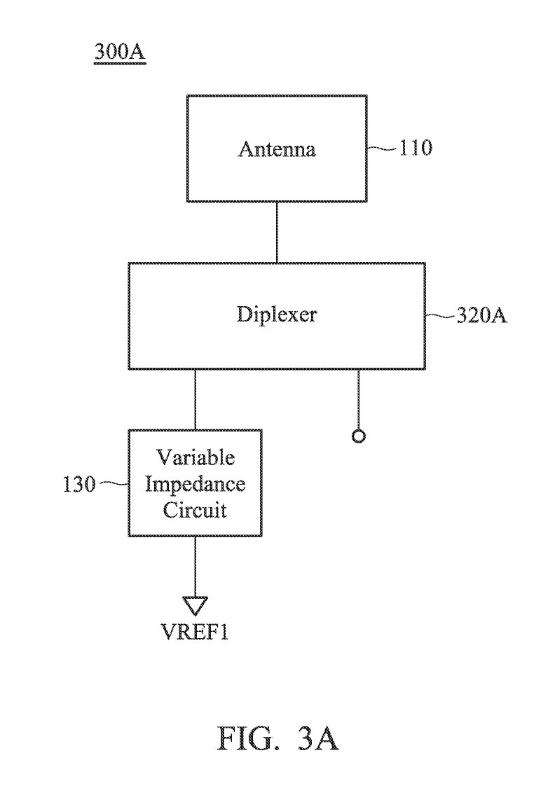

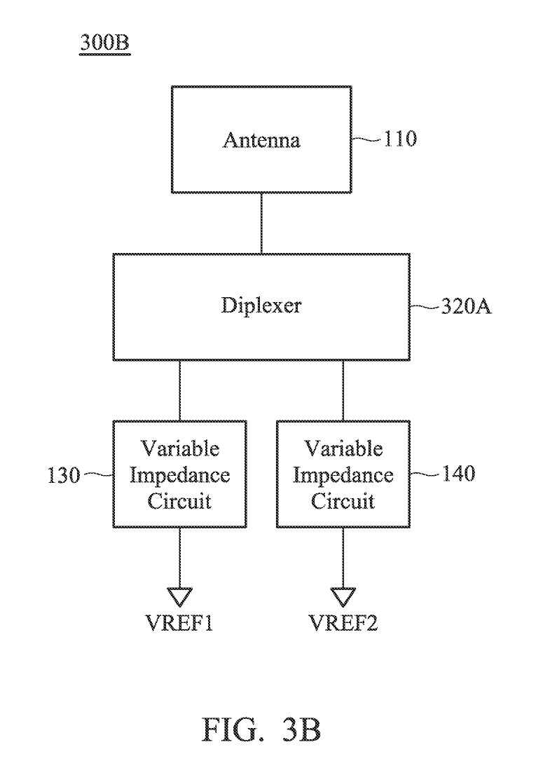

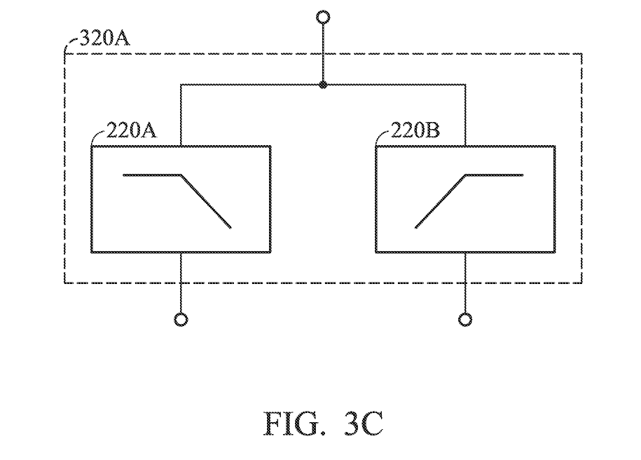

FIG. 3A is a diagram of a communication device 300A according to an embodiment of the invention. In the embodiment of FIG. 3A, the frequency dividing circuit of the communication device 300A is a diplexer 320A, and the number of variable impedance circuits 130 of the communication device 300A is one. The diplexer 320A has a first terminal (serving as the common port of the frequency dividing circuit) coupled to the antenna 110, a second terminal (serving as one output port of the frequency dividing circuit) coupled to the variable impedance circuit 130, and a third terminal (serving as another output port of the frequency dividing circuit) kept floated. The variable impedance circuit 130 is coupled between the second terminal of the diplexer 320A and a reference voltage VREF1 (e.g., a ground voltage VSS). The diplexer 320A performs the function of frequency division. For example, the inner structure of the diplexer 320A may be displayed in FIG. 3C. FIG. 3C is a diagram of the diplexer 320A according to an embodiment of the invention. In the embodiment of FIG. 3C, the diplexer 320A includes a low-pass filter 220A and a high-pass filter 220B. The low-pass filter 220A is coupled between the antenna 110 and the variable impedance circuit 130 (i.e., coupled between the first terminal and the second terminal of the diplexer 320A). The high-pass filter 220B is coupled to the antenna 110 (i.e., coupled between the first terminal and the third terminal of the diplexer 320A). The low-pass filter 220A and the high-pass filter 220B are configured to collectively divide low-frequency signals and high-frequency signals into different signal paths. Therefore, the high frequency sub-range and the low frequency sub-range are separated into different signal paths without tending to interfere with each other and output from different output ports of the frequency dividing circuit, respectively. Accordingly, the antenna 110 can switch between the different respective impedance values of the variable impedance circuit 130 in the low frequency sub-range independently from the high frequency sub-range. In alternative embodiments, the low-pass filter 220A and the high-pass filter 220B are interchanged with each other, and the antenna 110 can therefore switch between the different respective impedance values of the variable impedance circuit 130 in the high frequency sub-ranges independently from the low frequency sub-range so as to meet different design requirements.

FIG. 3B is a diagram of a communication device 300B according to an embodiment of the invention. In the embodiment of FIG. 3B, the frequency dividing circuit of the communication device 300B is a diplexer 320A, and the number of variable impedance circuits 130 and 140 of the communication device 300B is two. The diplexer 320A has a first terminal (serving as a common port of the frequency dividing circuit) coupled to the antenna 110, a second terminal (serving as one output port of the frequency dividing circuit) coupled to the variable impedance circuit 130, and a third terminal (serving as another output port of the frequency dividing circuit) coupled to the variable impedance circuit 140. The variable impedance circuit 130 is coupled between the second terminal of the diplexer 320A and a reference voltage VREF1 (e.g., a ground voltage VSS). The variable impedance circuit 140 is coupled between the third terminal of the diplexer 320A and the reference voltage VREF1 or a reference voltage VREF2 (e.g., the ground voltage VSS, or other different bias voltage). The diplexer 320A performs the function of frequency division. For example, the inner structure of the diplexer 320A may be displayed in FIG. 3C. The diplexer 320A may include a low-pass filter 220A and a high-pass filter 220B. The low-pass filter 220A is coupled between the antenna 110 and the variable impedance circuit 130 (i.e., coupled between the first terminal and the second terminal of the diplexer 320A). The high-pass filter 220B is coupled between the antenna 110 and the variable impedance circuit 140 (i.e., coupled between the first terminal and the third terminal of the diplexer 320A). In alternative embodiments, the low-pass filter 220A and the high-pass filter 220B are interchanged with each other. With such a design, the high frequency sub-range and the low frequency sub-range are separated into different signal paths without tending to interfere with each other and output from different output ports of the frequency dividing circuit, respectively. Accordingly, the antenna 110 can switch between the different respective impedance values of the variable impedance circuit 130 in the high frequency sub-range independently from the low frequency sub-range, and also can switch between the different respective impedance values of the variable impedance circuit 140 in the low frequency sub-range independently from the high frequency sub-range.

The above variable impedance circuit 130 (or 140) may be implemented with a variety of circuit structures. Please refer to the following embodiments. It should be understood that these embodiments are just exemplary, rather than limitations of the invention.

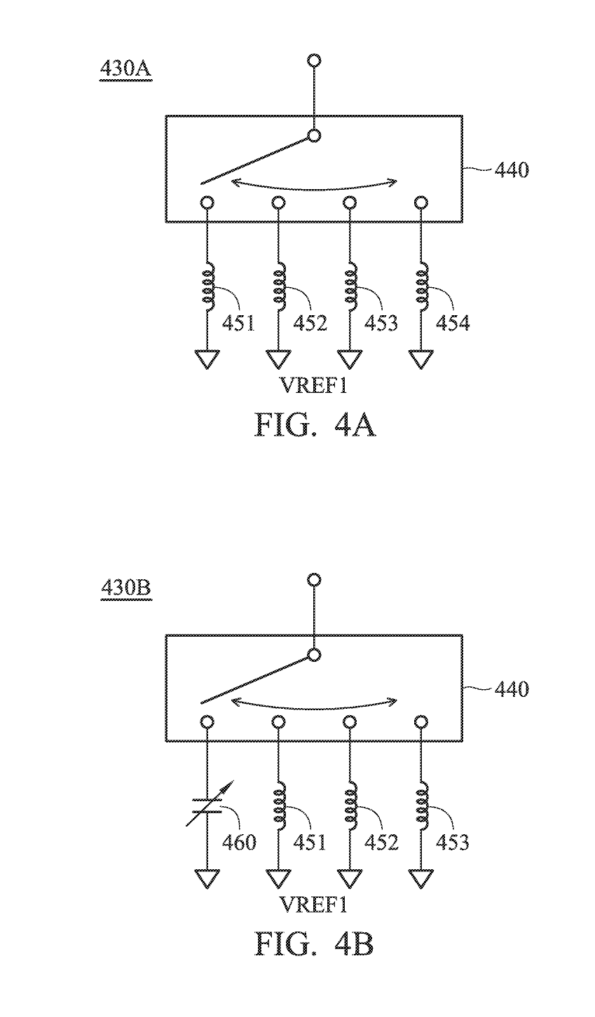

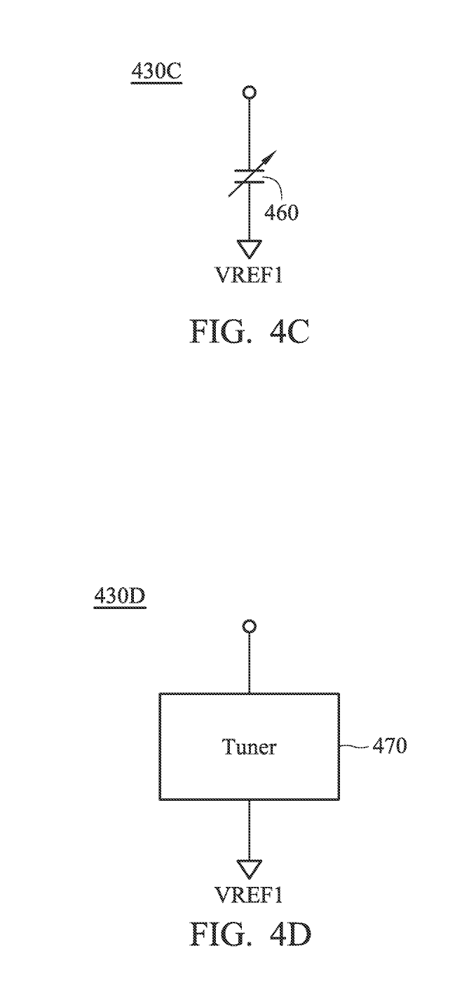

FIG. 4A is a diagram of a variable impedance circuit 430A according to an embodiment of the invention. In the embodiment of FIG. 4A, the variable impedance circuit 430A includes a switch element 440 and multiple inductors 451 to 454. The inductors 451 to 454 are coupled to a reference voltage VREF1, and they have different inductances. The switch element 440 can switch between the inductors 451 to 454, so that the variable impedance circuit 430A can provide different impedance values (i.e., inductance values of inductors 451-454) for the antenna 110.

FIG. 4B is a diagram of a variable impedance circuit 430B according to an embodiment of the invention. In the embodiment of FIG. 4B, the variable impedance circuit 430B includes a switch element 440, multiple inductors 451 to 453, and a variable capacitor 460. The inductors 451 to 453 are coupled to a reference voltage VREF1, and they have different inductances. The variable capacitor 460 is also coupled to the reference voltage VREF1, and it is configured to generate a variety of capacitances. The switch element 440 can switch between the variable capacitor 460 and the inductors 451 to 453, so that the variable impedance circuit 430B can provide different impedance values (i.e., capacitance values of capacitor 460 and inductance values of inductors 451-454) for the antenna 110.

FIG. 4C is a diagram of a variable impedance circuit 430C according to an embodiment of the invention. In the embodiment of FIG. 4C, the variable impedance circuit 430C includes a variable capacitor 460. The variable capacitor 460 is coupled to a reference voltage VREF1, and it is configured to generate a variety of capacitances, so that the variable impedance circuit 430C can provide different impedance values (variable capacitance value of variable capacitor 460) for the antenna 110.

FIG. 4D is a diagram of a variable impedance circuit 430D according to an embodiment of the invention. In the embodiment of FIG. 4D, the variable impedance circuit 430D includes a tuner 470. The tuner 470 is coupled to a reference voltage VREF1, and it is configured to generate a variety of impedance values, so that the variable impedance circuit 430D can provide different impedance values for the antenna 110.

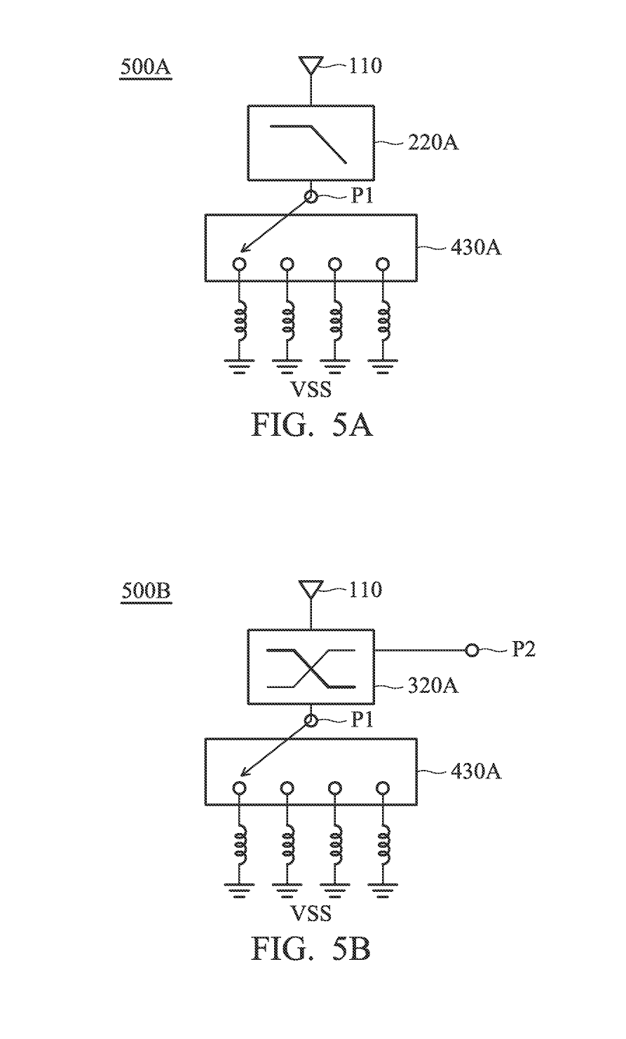

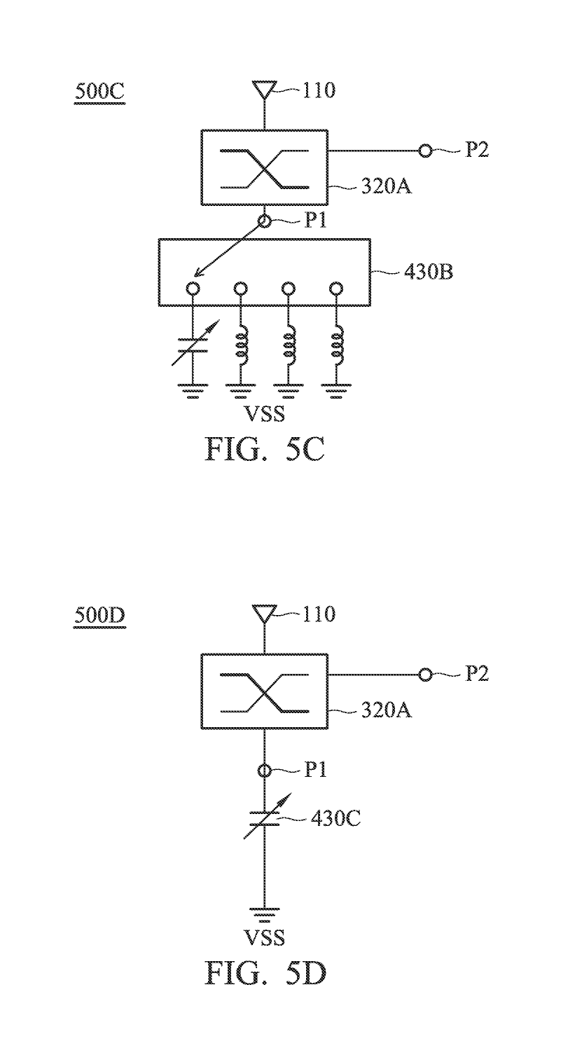

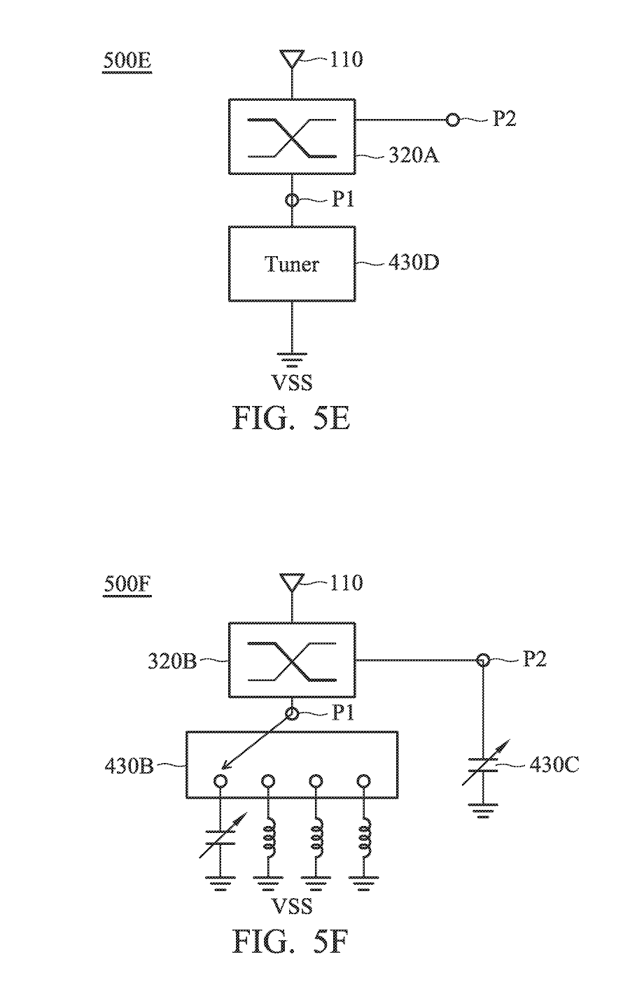

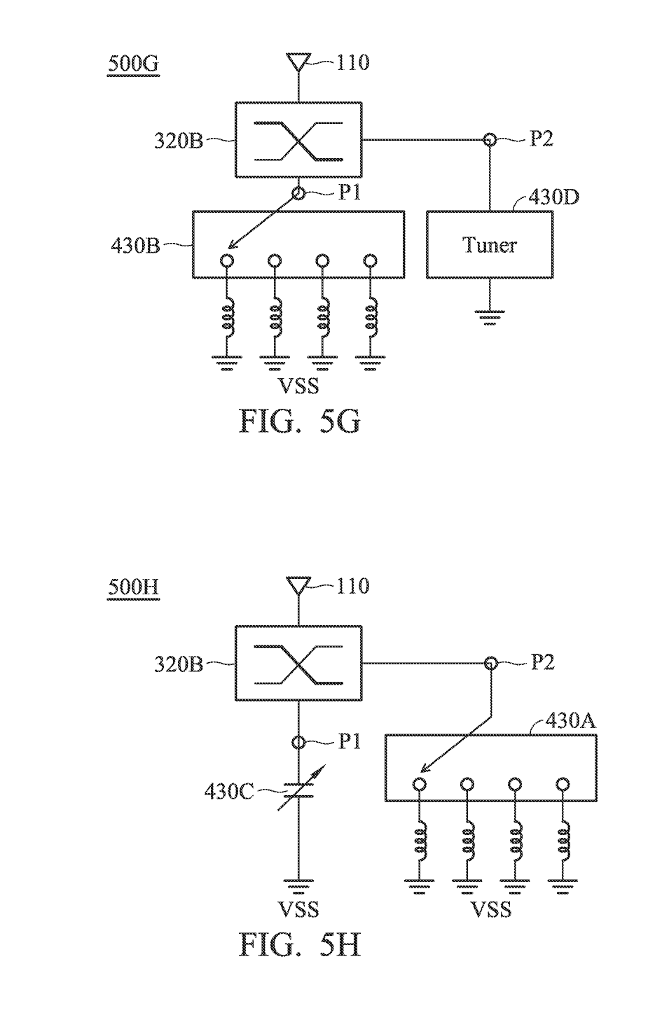

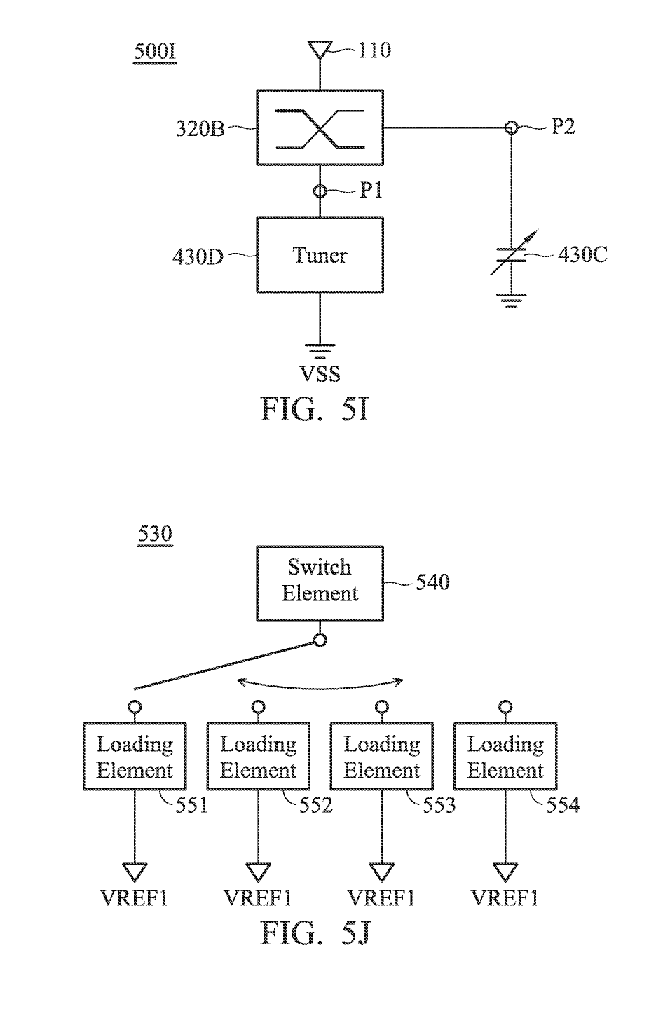

FIGS. 5A to 5I are diagram of communication devices 500A to 5001 according to some exemplary embodiments of the invention. In the embodiments of FIGS. 5A to 5I, the frequency dividing circuits of FIGS. 2A to 3C are respectively implemented in cooperation with the variable impedance circuits of FIG. 4A to 4D, so as to form the communication devices 500A to 5001. It should be noted that the frequency dividing circuit has one or more output ports (P1 and/or P2), which are respectively coupled to one or more variable impedance circuits. The output ports are arranged for separately output the frequency sub-ranges, e.g., the low/medium/high-frequency sub-ranges.

FIG. 5J is a diagram of at least one variable impedance circuit 530 according to an embodiment of the invention. Generally speaking, the variable impedance circuit 530 includes a first terminal, a second terminal, multiple loading elements 551 to 554, and a switch element 540. The first terminal of the variable impedance circuit 530 is coupled to a reference voltage VREF1 (e.g., a ground voltage VSS). The second terminal of the variable impedance circuit 530 is coupled to one of the output ports 125 of the frequency dividing circuit 120 (not shown). The loading elements 551 to 554 are coupled to one of the first terminal and the second terminal, and they have different impedance values. The switch element 540 is coupled to the other one of the first terminal and the second terminal, and it switches between the loading elements 551 to 554. The switch element 540 has a first terminal coupled to the output port 125 of the frequency dividing circuit 120, and a second terminal switchably coupled to one of the loading elements 551 to 554. At least one of the loading elements 551 to 554 includes one or more inductors, one or more variable capacitors, one or more fixed capacitors, or a combination thereof.

It is noted that in the embodiments of FIGS. 4A-4C and FIG. 5J, the loading elements are coupled between the switch element 440 and the reference voltage VREF1. However, in alternative embodiments, the switch element 440 and the loading elements can have their positions exchanged. Specifically, the switch element can be coupled between the loading elements and the reference voltage VREF1. In summary, at least one of the at least one variable impedance circuits can include a first terminal, coupled to the first reference voltage, a second terminal, coupled to one of the at least one output port of the frequency dividing circuit, a plurality of loading elements, coupled to one of the first terminal and the second terminal and having different impedances, and a switch element, coupled to the other one of the first terminal and the second terminal and switching between the loading elements.

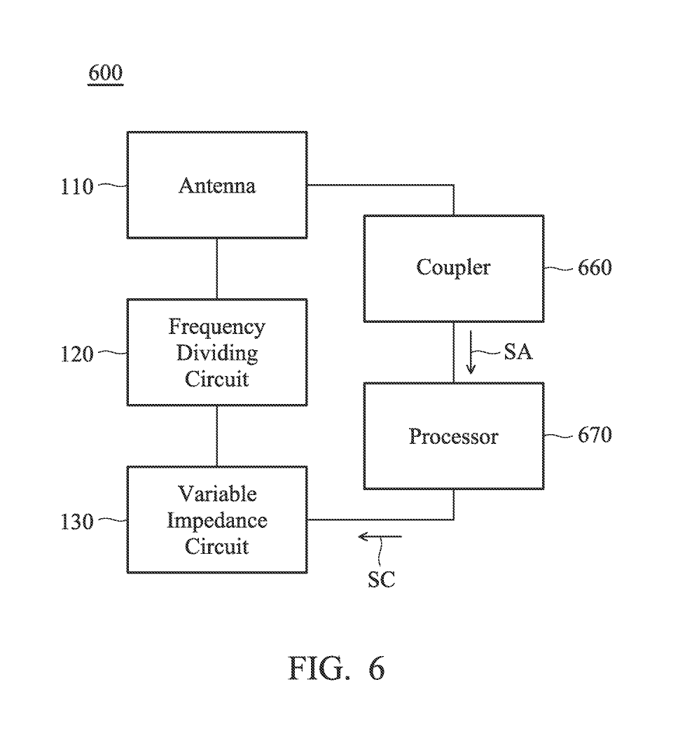

FIG. 6 is a diagram of a communication device 600 according to an embodiment of the invention. In the embodiment of FIG. 6, the communication device 600 includes an antenna 110, a frequency dividing circuit 120, at least one variable impedance circuit 130, a coupler 660, and a processor 670. The coupler 660 is coupled between the antenna 110 and the processor 670, and it provides communication information SA from the antenna 110 to the processor 670. The communication information SA may include return loss or RSSI (Received Signal Strength Indicator) of the antenna 110. The coupler 660 may be disposed at any position of the RF (Radio Frequency) path of the communication device 600. For example, the coupler 660 may be positioned on the antenna 110, or on a frame of a mobile phone. The processor 670 receives the communication information SA directly or indirectly from the antenna 110, and generates at least one control signal SC according to the communication information SA. The impedance value of each variable impedance circuit 130 can be determined according to one of the control signals SC.

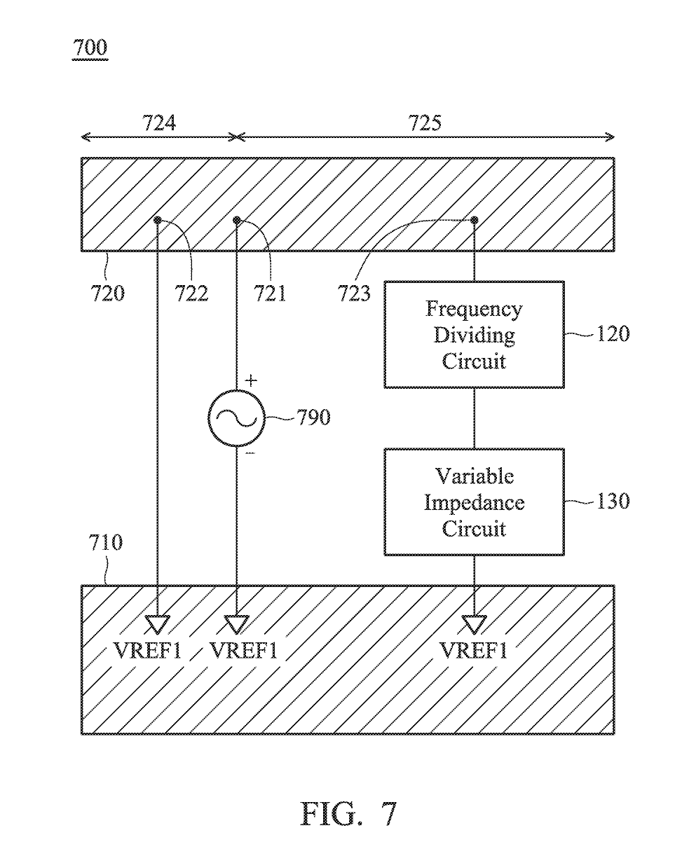

FIG. 7 is a diagram of a communication device 700 according to an embodiment of the invention. In the embodiment of FIG. 7, the communication device 700 includes an antenna, a frequency dividing circuit 120, and at least one variable impedance circuit 130. The antenna includes a ground/reference plane 710, and one or more radiation elements 720. The ground/reference plane 710 and the one or more radiation elements 720 may be made of metal materials, such as silver, copper, aluminum, iron, or their alloys. The ground/reference plane 710 and the radiation elements 720 may be disposed on a dielectric substrate (not shown), such as a printed circuit board or an FR4 (Flame Retardant 4) substrate. For example, the ground/reference plane 710 may substantially have a rectangular shape, and one of the radiation elements 720 may substantially have a straight-line shape. A feeding point 721 of one of the radiation elements 720 is coupled to a positive electrode of a signal source 790. A negative electrode of the signal source 790 is coupled to the ground/reference plane 710. The ground/reference plane 710 provides a reference voltage VREF1 (e.g., a ground voltage VSS). The grounding point 722 of one of the radiation elements 720 can be directly coupled to the ground/reference plane 710. The tuning point 723 of one of the radiation elements 720 is coupled through the frequency dividing circuit 120 and the variable impedance circuit 130 to the reference voltage VREF1. In some embodiments, the grounding point 722, the feeding point 721, and the tuning point 723 are arranged in a straight line. The feeding point 721 may be positioned between the grounding point 722 and the tuning point 723. In some embodiments, the antenna further includes one or more reference points. Each of the reference points is coupled to a reference voltage VREF2, which is the same or different from the reference voltage VREF1, and is further coupled to a corresponding radiation element 720.

The antenna can operate in multiple frequency sub-ranges without interference therebetween. For example, a first current path 724 from the feeding point 721 to the left open end of the radiation element 720 may be excited to generate a medium/high-frequency sub-range, and a second current path 725 from the feeding point 721 to the right open end of the radiation element 720 may be excited to generate a low-frequency sub-range. In some embodiments, the frequency dividing circuit 120 is a diplexer for separating medium/high-frequency sub-ranges to obtain the low-frequency sub-range, so that they do not tend to negatively affect each other. In such a manner, the second current path 725 can be completely separated from the first current path 724 by the frequency dividing circuit 120, and the harmonic interference between high/medium/low frequency sub-ranges in the communication device 700 can be effectively suppressed.

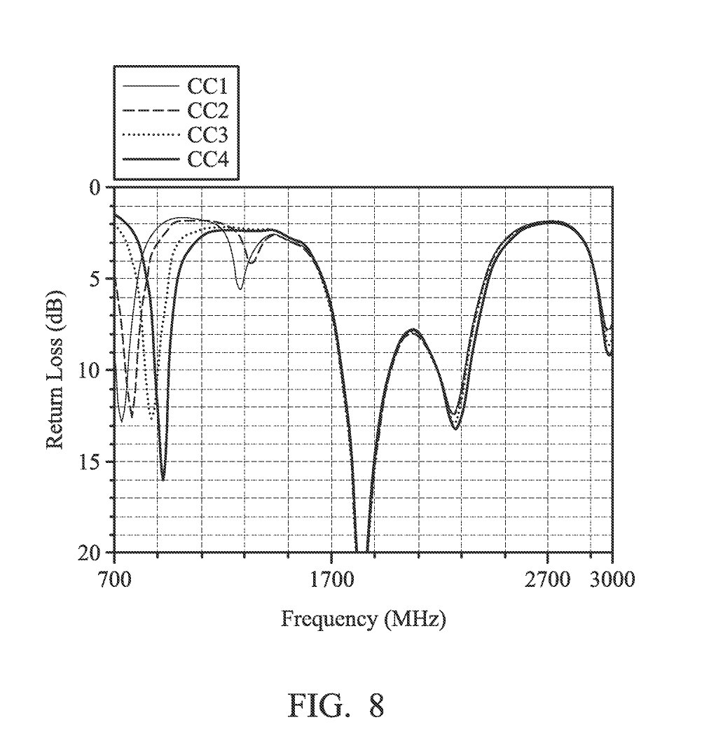

FIG. 8 is diagram of return loss of the antenna of the communication device 700 according to an embodiment of the invention. The horizontal axis represents operation frequency (MHz) of the antenna, and the vertical axis represents the return loss (dB) of the antenna. The curves CC1 to CC4 represent different operating states of the respective variable impedance circuit 130. For example, referring to the embodiments of FIG. 4A, when the switch element 440 switches to the inductors 451 to 454, the corresponding return loss of the antenna may be displayed as the curves CC1 to CC4, respectively. In the embodiment of FIG. 8, the frequency dividing circuit 120 of the communication device 700 is a low-pass filter or a diplexer for frequency division. It is noted that not all output port(s) are illustrated. With such a design, when the variable impedance circuit 130 performs a switching operation, only the low-frequency current path is affected, and it has almost no impact on the medium/high-frequency current paths. According to the measurement of FIG. 8, during the switching operation of the variable impedance circuit 130, the return loss of the antenna operating in the medium/high-frequency bands is almost the same, and only the return loss of the antenna operating in the low-frequency sub-range is changed accordingly. Since the signal paths of different frequency sub-ranges do not tend to negatively affect each other, the harmonic interference in the communication device 700 is significantly improved.

In one embodiment, an electronic device for use in a communication device such as the communication device is also disclosed. The electronic device may include an antenna terminal, configured to be coupled to an antenna such as antenna 110, a frequency dividing circuit such as the frequency dividing circuit 120, and at least one variable impedance circuit such as the frequency dividing circuit 130. The frequency dividing circuit can have a common port coupled to the antenna terminal and at least one output port, and configured to divide a frequency range received from the common port into a plurality of frequency sub-ranges and output at least one of the frequency sub-ranges respectively at the at least one output port. Each of the at least one variable impedance circuit can be coupled between a corresponding one of the at least one output port of the frequency dividing circuit and a respective first reference voltage, and can provide a respective variable impedance value switched between different respective impedance values. More details can be analogized from the descriptions in connection to the above embodiments.

The embodiments in disclosure propose a novel communication device with a frequency dividing circuit or a frequency dividing mechanism. The frequency dividing circuit may be implemented with a low-pass filter, a high-pass filter, a band-pass filter, a diplexer, duplexer, tri-plexer, quad-plexer, or a combination thereof. With such a design, low/medium/high-frequency components or sub-ranges do not tend to negatively affect each other, and harmonic interference in the communication device can be effectively eliminated. In comparison to the conventional design, the embodiments can provide at least the following advantages: (1) widening the bandwidth of a communication device for carrier aggregation, (2) suppressing the harmonic interference in the communication device, (3) simplifying the structure of the control circuits of the communication device, and (4) reducing the manufacturing cost of the communication device.

The above embodiments are just exemplary, rather than limitations of the invention. It should be understood that the communication device is not limited to the configuration of FIGS. 1 to 8. The invention may merely include any one or more features of any one or more embodiments of FIGS. 1 to 8. In other words, not all of the features shown in the figures should be implemented in the communication device of the invention.

The above terms “at least one” or “one or more” mean any positive integer which is greater than one or is equal to one. The number of elements in FIGS. 1 to 8 is not a limitation of the invention. For example, in the embodiments of FIG. 3B, although there are exactly two variable impedance circuits 130 and 140 displayed in the figure, it should be understood that any positive number of variable impedance circuits, such as 2, 3, 4, 5, or more, may be used and respectively coupled to the output ports of the diplexer 320A. For example, in the embodiments of FIG. 4A, although there are exactly four inductors displayed in the figure, it should be understood that any positive number of inductors, such as 2, 3, 4, 5, or more, may be used for providing different inductances.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication device, comprising:
an antenna;
a frequency dividing circuit, having a common port coupled to the antenna and at least one output port, and configured to divide a frequency range received from the common port into a plurality of frequency sub-ranges and output at least one of the frequency sub-ranges respectively at the at least one output port; and
at least one variable impedance circuit, each coupled between a corresponding one of the at least one output port of the frequency dividing circuit and a respective first reference voltage, and providing a respective variable impedance value switched between different respective impedance values.

2. The communication device as claimed in claim 1, wherein the antenna switches between the different respective impedance values in at least one of the frequency sub-ranges independently from the other one or more frequency sub-ranges.

3. The communication device as claimed in claim 1, wherein the first reference voltage is a ground voltage.

4. The communication device as claimed in claim 1, wherein the frequency dividing circuit is a passive element.

5. The communication device as claimed in claim 1, wherein the frequency dividing circuit is an active element.

6. The communication device as claimed in claim 1, wherein a range of at least one of the at least one of the frequency sub-ranges respectively output at the at least one output port is dynamically changed.

7. The communication device as claimed in claim 1, wherein each output port of the frequency dividing circuit is coupled to a respective one of the at least one variable impedance circuit.

8. The communication device as claimed in claim 1, wherein at least one output port of the frequency dividing circuit is not coupled to any of the at least one variable impedance circuits.

9. The communication device as claimed in claim 1, wherein the at least one output port of the frequency dividing circuit not coupled to any of the at least one variable impedance circuit is float, short to a second reference voltage different or the same as the first reference voltage, or coupled to a loading element.

10. The communication device as claimed in claim 1, wherein the frequency dividing circuit comprises a low-pass filter, a high-pass filter, a band-pass filter, a diplexer, duplexer, tri-plexer, quad-plexer, or a combination thereof.

11. The communication device as claimed in claim 1, wherein at least one of the at least one variable impedance circuits comprises:
a first terminal, coupled to the first reference voltage;
a second terminal, coupled to one of the at least one output port of the frequency dividing circuit;
a plurality of loading elements, coupled to one of the first terminal and the second terminal and having different impedances; and
a switch element, coupled to the other one of the first terminal and the second terminal and switching between the loading elements.

12. The communication device as claimed in claim 11, wherein the switch element comprises:
a first terminal, coupled to the output port of the frequency dividing circuit; and
a second terminal, switchably coupled to one of the loading elements.

13. The communication device as claimed in claim 12, wherein at least one of the loading elements comprises one or more inductors, one or more variable capacitors, one or more fixed capacitors, or a combination thereof.

14. The communication device as claimed in claim 1, wherein at least one of the at least one variable impedance circuit comprises
a tuner, coupled to the first reference voltage, and generating different impedance values.

15. The communication device as claimed in claim 1, further comprising:
a processor, receiving communication information directly or indirectly from the antenna, and generating at least one control signal according to the communication information;
wherein an impedance value of each of the at least one variable impedance circuit is determined according to one of the at least one control signal.

16. The communication device as claimed in claim 1, further comprising:
a coupler, coupled between the antenna and the processor, and providing the communication information from the antenna to the processor.

17. The communication device as claimed in claim 1, wherein the antenna comprises:
a feeding point, coupled to a signal source;
one or more radiation elements, wherein one of the one or more radiation elements is coupled to the feeding point; and
a tuning point, coupled through the frequency dividing circuit and the at least one variable impedance circuit to the first reference voltage.

18. The communication device as claimed in claim 17, wherein the antenna further comprises:
a ground/reference plane, providing the first reference voltage.

19. The communication device as claimed in claim 17, wherein the antenna further comprises:
one or more reference points, each coupled to a second reference voltage the same or different from the first reference voltage and a corresponding one of the one or more radiation elements.

20. The communication device as claimed in claim 19, wherein the first reference voltage is a ground voltage.

21. An electronic device in a communication device, comprising:
an antenna terminal, configured to be coupled to an antenna;
a frequency dividing circuit, having a common port coupled to the antenna terminal and at least one output port, and configured to divide a frequency range received from the common port into a plurality of frequency sub-ranges and output at least one of the frequency sub-ranges respectively at the at least one output port; and
at least one variable impedance circuit, each coupled between a corresponding one of the at least one output port of the frequency dividing circuit and a respective first reference voltage, and providing a respective variable impedance value switched between different respective impedance values.
